(19) United States
(12) Patent Application Publication
(10) Pub. No.: US 2010/0271914 A1
(43) Pub. Date: Oct. 28, 2010

(54) DRIVE APPARATUS

(75) Inventors: Johan Cornelis Talstra, Eindhoven (NL); Loek Faessen, Venlo (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,530

(22) PCT Filed: Dec. 16, 2008
(86) PCT No.: PCT/IB08/55322

§ 371 Date: Jun. 11, 2010

(30) Foreign Application Priority Data
Dec. 18, 2007 (EP) 07123448.8

(51) Int. Cl. G11B 20/10

(52) U.S. Cl. 369/47.15; G9B/20.009

(57) ABSTRACT

The present invention relates to a drive apparatus (20) for accessing an optical record carrier (10) carrying a time-indicative information (T) and a second ROM mark (M₂), comprising: —an access unit (21, 25) for accessing said record carrier (10) for reading data from and/or writing data to said record carrier (10), —a time-information detector (D3) for checking for the presence of time-indicative information (T) and for checking, if time-indicative information (T) is present, whether said time-indicative information (T) indicates a time that lies before a predetermined reference time, —a second ROM mark detector (D₂) for checking, if said time-indicative information (T) indicates a time that lies on or after said predetermined reference time, for the presence of said second ROM mark (M₂), and—a controlunit (23, 24) for controlling said access unit (21, 25) such that the reading and/or writing of data is inhibited if said time-indicative information (T) indicates a time that lies on or after said predetermined reference time, but said second ROM mark (M₂) is not present on said record carrier.

### FIELD OF THE INVENTION

The present invention relates to a drive apparatus for accessing an optical record carrier carrying a time-indicative information and a second ROM mark. The present invention relates further to a corresponding drive method, to a record carrier, to a manufacturing apparatus for manufacturing a record carrier, and to a corresponding manufacturing method.

### BACKGROUND OF THE INVENTION

Due to the still growing piracy of content information stored on optical record carriers there is a large need for copy-protection measures. A variety of approaches have been made, one of these approaches being the provision of an additional feature on the optical record carrier (also called “disc” in the following), i.e. the so-called “ROM mark”, which, when a copy is made with consumer equipment, e.g. a CD-R/W drive, is not passed to the copy.

Several examples of ROM marks known in the art, in particular in relation to optical discs such as CDs, DVDs, and BDs, are variations in the radial position, width or height of the track, in the density of data present along the track, in special patterns of correctable errors, in which case such ROM mark is also known as side channel or hidden channel as, for instance, described in EP 0 930 614 B1. Other examples of ROM marks known in the art are holograms, stamped patterns, and barcodes in the BCA.

By use of such ROM marks, an original disc can easily be distinguished from a copy, and access to the content information can be granted simply upon the detection of the ROM mark, or upon extraction of some kind of information from said ROM mark, which is essential to allow access to the content information, e.g. a decryption key.

In WO2007/063432A2, a method is proposed for copy protection, according to which instead of a single ROM mark, many ROM marks are applied to a disc. Further, devices (drive apparatuses) are divided into groups, and each group has the capability to only detect one mark from the group. This way, if a secret is obtained from a device, the disc can be duplicated, but only a limited number of devices will be able to use this disc. Creating a disc that can be played in any device requires the hacking of one device from every group.

### SUMMARY OF THE INVENTION

It is an object of the present invention to provide a drive apparatus and a corresponding drive method enabling copy protection with less complicated means, in particular without the need to introduce many ROM marks which need to be stored on every disc. It is a further object of the present invention to provide a record carrier for use in such a drive apparatus and a manufacturing apparatus and method for manufacturing such a record carrier.

In a first aspect of the present invention, there is provided a drive apparatus for accessing an optical record carrier carrying a time-indicative information and a second ROM mark, comprising:
an access unit for accessing said record carrier for reading data from and/or writing data to said record carrier,
a time-information detector for checking for the presence of time-indicative information and for checking, if time-indicative information is present, whether said time-indicative information indicates a time that lies before a predetermined reference time,
a second ROM mark detector for checking, if said time-indicative information indicates a time that lies on or after said predetermined reference time, for the presence of said second ROM mark, and
a control unit for controlling said access unit such that the reading and/or writing of data is inhibited if said time-indicative information indicates a time that lies on or after said predetermined reference time, but said second ROM mark is not present on said record carrier.

In a second aspect of the present invention, there is provided a record carrier carrying a time-indicative information for use by a drive apparatus for checking whether said time-indicative information indicates a time that lies before a predetermined reference time, and carrying a second ROM mark, said time-indicative information and said second ROM mark being provided for use by a drive apparatus for deciding whether or not allowing access to said record carrier.

In a third aspect of the present invention, there is provided a manufacturing apparatus for manufacturing a record carrier, comprising:
a time-information inserter for inserting a time-indicative information on said record carrier for use by a drive apparatus (20) for checking for the presence of time-indicative information on said record carrier and for checking, if time-indicative information is present, whether said time-indicative information indicates a time that lies before a predetermined reference time, and
a second ROM mark inserter for inserting a second ROM mark for use by said drive apparatus for checking, if said time-indicative information indicates a time that lies on or after said predetermined reference time, for the presence of said second ROM mark.

In further aspects of the present invention, there are provided a drive method and a manufacturing method, respectively, as defined in further independent claims. Preferred embodiments of the invention are defined in the dependent claims. It shall be noted that the preferred embodiments defined in the dependent claims referring to the drive apparatus and the record carrier, respectively, shall equivalently be understood as embodiments of the drive method, manufacturing apparatus and manufacturing method.

If a ROM mark has been hacked partially or in full, then it might be replaced by another different secure system, e.g. a second ROM mark, which may from a system point of view be totally independent from the previous ROM mark. However, then the installed base of drive apparatuses will not be able to play the new type of discs (carrying the second ROM mark), and all previously sold discs that bear the first (old) ROM mark will not play on the new type of drive apparatuses.

Based on this recognition, it is the idea of the present invention to introduce a second ROM mark on new discs and to check a certain part of the first ROM mark, before the disc will be tested on the presence of the second ROM mark. This certain part of the first ROM mark which is checked now includes a time-indicative information indicating a certain time which is also checked with respect to a predetermined reference time, said predetermined reference time being, for instance, the day of manufacture of the master disc that has been used to manufacture the present disc which shall currently be accessed.

In other words, the drive apparatus according to the present invention can distinguish between “old” discs and “new” discs. An “old” disc has only a first ROM mark and either no time-indicative information at all, or a time-indicative information indicating a time that lies before the predetermined reference time used for checking whether the disc is an “old” disc or a “new” disc. A “new” disc carries both a time-indicative information (indicating a time that lies on or after said predetermined reference time) and a second ROM mark. If it will be found that a checked disc carries a time-indicative information which indicates a time that lies on or after said predetermined reference time but carries no second ROM mark, then it is decided that this disc is not allowed to be accessed because it is not an original, but a copy or a hacked disc.

By use of the present invention, usually the access in the form of read access is controlled. However, also a write access can be controlled as well.

Preferably, the optical record carrier further carries a first ROM mark. This enables that “old” drive apparatuses having only a first ROM mark detector but no second ROM mark detector can access both the “old” discs and the “new” discs since such “old” drive apparatuses simply check for the presence of the first ROM mark. If it is present then access is granted and otherwise not. The second ROM mark and any time-indicative information are usually ignored by those “old” drive apparatuses.

It is further preferred that the drive then comprises a first ROM mark detector for checking for the presence of said first ROM mark. Thus, also “old” discs carrying only a first ROM mark but no second ROM mark (and no time-indicate information) can be checked according to the conventional check mechanism, which provides an increased security.

According to a further embodiment the said time-indicative information is included in said first ROM mark and said time-information detector is adapted for checking for the presence of time-indicative information in said first ROM mark. This embodiment also provides more security.

Rather than including the time-indicative information in said first ROM mark, it is also possible, for prevention of counterfeiting, that the time-indicative information is included in some digital signature of the same or hashed together with part of the content.

In a preferred embodiment, it is proposed that the control unit is adapted for controlling said access unit such that the reading and/or writing of data is allowed if either said time-indicative information is not present or if said time-indicative information indicates a time that lies before said predetermined reference time, or if said second ROM mark is present on said record carrier. It is generally a question of how to design the control rule, whether the control rule is such that access is denied if certain conditions are fulfilled or if access is allowed if certain (other) conditions are fulfilled.

Preferably, the time-indicative information specifies a particular point in time either directly or indirectly. A direct specification, for instance, specifies the date of manufacturing the record carrier or, alternatively, the date of manufacturing the master which has been used for manufacturing the present record carrier.

Various embodiments according to which a particular point in time is indirectly specified by the time-indicative information are defined in further dependent claims. For instance, the indirect information could be a unique information allowing to determine a predetermined point in time. This could be obtained by storing pieces of unique information in the drive apparatus and by checking a detected piece of unique information against the stored pieces of unique information stored in the drive apparatus, e.g. in a unique information storage.

Such a unique information could also be a unique random number, in which case the drive apparatus stores previously used unique random numbers which are then used for checking them against the detected unique random number. If the detected unique random number (or generally, the unique information) detected by the drive apparatus in the first ROM mark is not stored in the drive apparatus (e.g. in the unique information storage), then this delivers the information to the drive apparatus that the time indirectly indicated by the time-indicative information lies after said predetermined reference time, so that a second ROM mark must be present on the record carrier to get allowance for accessing said record carrier.

Rather than storing previously used unique information, e.g. previously used random numbers in a storage of the drive, it is also possible that it is stored on all new record carriers for read-out by the drive, so that the drive can use it for the check to be performed. Further, this can also be used to update the storage.

According to a preferred embodiment it is proposed that said time-information detector is adapted for checking for the presence of time-indicative information in a certificate stored on the record carrier, in particular a content certificate, content revocation list or a Blu-ray Disc certificate like the BD-J root certificate. This provides additional security for protection for the time-indicative information against hacking Preferably, certain information that is already provided in a certificate for other purposes (e.g. for decrypting content or approving content for playback) can be used to serve as the time-indicative information (at least indirectly), so that a hacker is not able to manipulate this time-indicative information since he would otherwise disable the original function of the respective information included in the certificate.

In a further embodiment of the record carrier it is proposed that pieces of unique information are used as time-indicative information on other record carriers manufactured before the manufacturing of the present record carrier or the master used for manufacturing the present record carrier. Thus, the pieces of unique information do not necessarily need to be stored in the drive apparatus itself, but can be distributed by the record carriers itself. For instance, in this way drive apparatuses can also be updated with the newest version of those pieces of unique information.

In a further embodiment it is proposed that the record carrier stores content material in encrypted form, which is encrypted such that time-indicative information present on said record carrier is to be used for decrypting said content material. Thus, if a hacker changes the time-indicative information to circumvent the protection provided by the present invention, the drive apparatus does not decrypt properly, which, hence, provides an additional level of security.

### BRIEF DESCRIPTION OF THE DRAWINGS

These and other features of the present invention will now be explained below with reference to the drawings in which

FIG. 1 shows a schematic block diagram of a first embodiment of a drive apparatus according to the present invention,

FIG. 2 shows a flow chart of a first embodiment of a drive method according to the present invention,

FIG. 3 shows a schematic block diagram of a first embodiment of a manufacturing apparatus according to the present invention,

FIG. 4 shows a schematic block diagram of a second embodiment of the drive apparatus according to the present invention,

FIG. 5 shows a schematic block diagram of a third embodiment of a drive apparatus according to the present invention,

FIG. 6 shows a schematic block diagram of a second embodiment of a manufacturing apparatus according to the present invention.

FIG. 7 shows a schematic block diagram of a fourth embodiment of a drive apparatus according to the present invention,

FIG. 8 shows a schematic block diagram of a fifth embodiment of a drive apparatus according to the present invention, and

FIG. 9 shows a schematic block diagram of a third embodiment of a manufacturing apparatus according to the present invention.

### DETAILED DESCRIPTION OF THE EMBODIMENTS

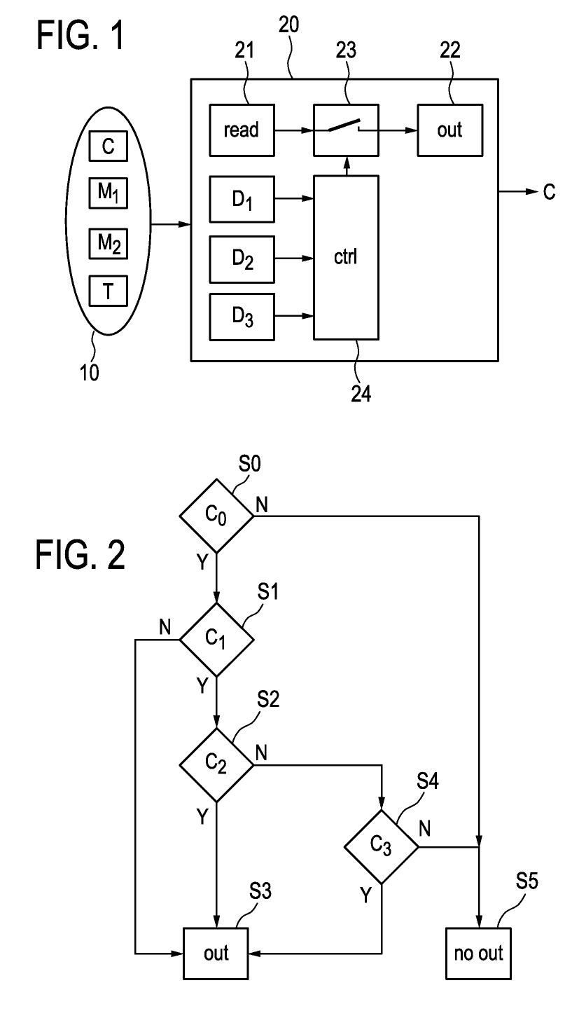

A schematic block diagram of a first embodiment of the drive apparatus according to the present invention is shown in FIG. 1. The record carrier 10 to be accessed by the drive apparatus 20 comprises content information C, a first ROM mark M₁, a second ROM mark M₂ and time-indicative information T which directly indicates a particular point in time, e.g. the date of manufacture of the record carrier 10 itself or the date of manufacture of a master which has been used for manufacturing the record carrier 10. The record carrier 10 can be a CD, a DVD, or a BD, and the content information C can, for instance, be audio, video or software data. Both the first and second ROM marks M₁, M₂, and preferably also the time-indicative information T, are additional features present on the record carrier 10, e.g. physical features such as a variation of the radial position, width or height of the track, which generally cannot be copied with regular consumer equipment and, thus, generally enables distinguishing between an original and a copy. Generally, the time-indicative information T can also be protected against illegal modifications by other means, e.g. by use of a digital signature or a hash code using part of the content information and/or of the first or second ROM marks M₁, M₂ to generated said hash code.

The drive apparatus 20 can be a consumer device, such as a CD player, a DVD player or a BD player, or a PC drive used in connection with a computer or other host device. The drive apparatus 20 includes a reading unit 21 used for reading the content C from the record carrier 10 and an output unit 22 for outputting content C from the drive apparatus. Reading unit 21 and output unit 22 are connected by a kind of controlled switching means 23, so that the data connection can be opened and closed under control of a control unit 24 in order to allow or inhibit output of the read content information C from the drive apparatus. The control unit 24 controls these switching means 23 based on the information provided by a first ROM mark detector D₁, a second ROM mark detector D₂ and a time-information detector D₃.

The first ROM mark detector D₁ is provided for checking for the presence of a first ROM mark M₁. This first check is illustrated as check C₀ made in step S0 shown in the flow chart illustrated in FIG. 2. If this first check C₀ provides a positive result, i.e. if a first ROM mark M₁ is present on the record carrier 10, the next check C1 will be carried out; otherwise, it is decided according to this embodiment that the record carrier is manipulated or a copy, and the output of the read content C is inhibited by opening the switch of the switching means 23 (step S5 in FIG. 2)

In the next check C₁ in step S1 the time-information detector D₃ for the presence of time-indicative information T on the record carrier 10. If this check C₁ provides a positive result, i.e. if time-indicative information T is present on the record carrier 10, a third check C₂ shown in step S2 is carried out in which it is checked by the time-information detector D₃ whether said time-indicative information T indicates a time that lies before a predetermined reference time or not, said reference time indicating, for instance, a time from which on second ROM marks M₂ have been used on new record carriers.

If said check C₂ provides a positive result, it is decided that the present record carrier is an “old” record carrier carrying no second ROM mark M₂, and the content C is allowed to be outputted (step S3), so that the control unit 24 controls the switching means 23 to close the switch between the reading unit 21 and the output unit 22.

If the check C₂ in step S2 provides a negative result, i.e. if it has been found that the time-indicative information T indicates a time that lies on or after that predetermined reference time, it should be a “new” record carrier and the second ROM mark detector D₂ (step S4 in FIG. 2) then checks in check C₃ if a second ROM mark M₂ is present on the record carrier 10. If this is the case, it is decided that the record carrier 10 has not been compromised and/or is not a copy, so that again the read content C is allowed to be outputted (step S3). If, however, no second ROM mark M₂ can be found in check C₃, the output of the read content C is inhibited by opening the switch of the switching means 23 (step S4 in FIG. 2), since it is assumed that the record carrier 10 is a new record carrier and should—but does not—carry a second ROM mark M₂ which is interpreted as an indication that the record carrier 10 has been compromised or is a copy.

It shall be noted that, in case check C₁ in step S1 shows that no time-indicative information T is present on the record carrier 10, the access to the record carrier 10 is granted and the content C is allowed to be outputted (step S3).

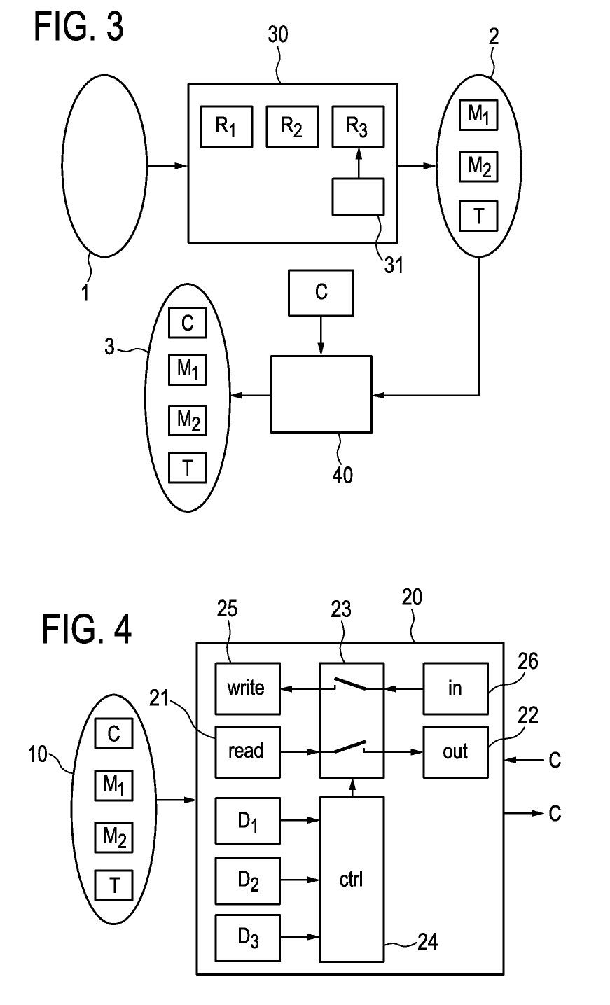

FIG. 3 schematically illustrates the manufacturing of a master according to the present invention. A first manufacturing unit 30 comprises a first ROM mark inserter R₁ and a second ROM mark inserter R₂ for generating said first and second ROM marks M₁, M₂ and inserting these ROM marks on a raw master 1 resulting in a master 2 having these first and second ROM marks M₁, M₂. Further, a time-information inserter R₃ is provided for generating and inserting the time-indicated information T on the raw master 1. The time-information inserter R₃ is provided with a time-indicative information T from a secure clock and/or any other time code specifying unit 31. Preferably, said time-indicative information T indicates the day on which the master 2 has been made and provided with the first and second ROM marks M₁, M₂ and the time-indicative information T.

The master 2 is then used by a second manufacturing unit 40 by which the content information C is put onto the master 2, resulting in the master 3 now carrying the content information C, the first and second ROM marks M₁, M₂ and the time-indicative information T. The master 3 can now be used for replicating a large number of record carriers for use by consumers. This way of replicating record carriers by use of a master is generally known in the art and shall not be explained in detail here. It shall just be noted that, of course, the first and second ROM marks M₁, M₂ and the time-indicative information T are, besides the content information C, also replicated on all those record carriers, i.e. all record carriers manufactured by use of the same master carry the same first and second ROM marks and the same time-indicative information T.

It shall be noted further that the above procedure of sequentially generating the ROM marks, the time-indicative information and the content information on the master is just an embodiment. According to alternative embodiments the sequence can be different or the ROM marks, the time-indicative information T and/or the content information can be generated in parallel.

It is, however, not necessarily required that the record carrier 10 has been made by use of a master 3, but the record carrier 10 can also be a unique record carrier made directly by certain manufacturing equipment. In this case it is preferred that the time-indicative information T (directly or indirectly) specifies this point in time on which the record carrier 10 itself has been manufactured.

FIG. 4 schematically illustrates a block diagram of a second embodiment of a drive apparatus according to the present invention. The drive apparatus 20 of this embodiment is generally quite similar to the drive apparatus 20 as shown in FIG. 1. In addition to the elements shown in FIG. 1, the drive apparatus 20, however, is not only provided for controlling a read access to content C stored on the record carrier 10 but also for controlling a write access for writing content on the record carrier 10. In particular, the drive apparatus 20 additionally comprises a write unit 25 and an input unit 26 being connected by the switching means 23. The control unit 24 is now also able to control the switch in the connection between the input unit 26 and the write unit 25 based on the information provided from the first and second ROM mark detectors D₁, D₂ and the time-information detector D₃. Generally, the control of the switch in a connection between the input unit 26 and the write unit 25 applies the same control rules as used for controlling the switch in the connection between the reading unit 21 and the output unit 22. However, it is possible that a different control rule is applied.

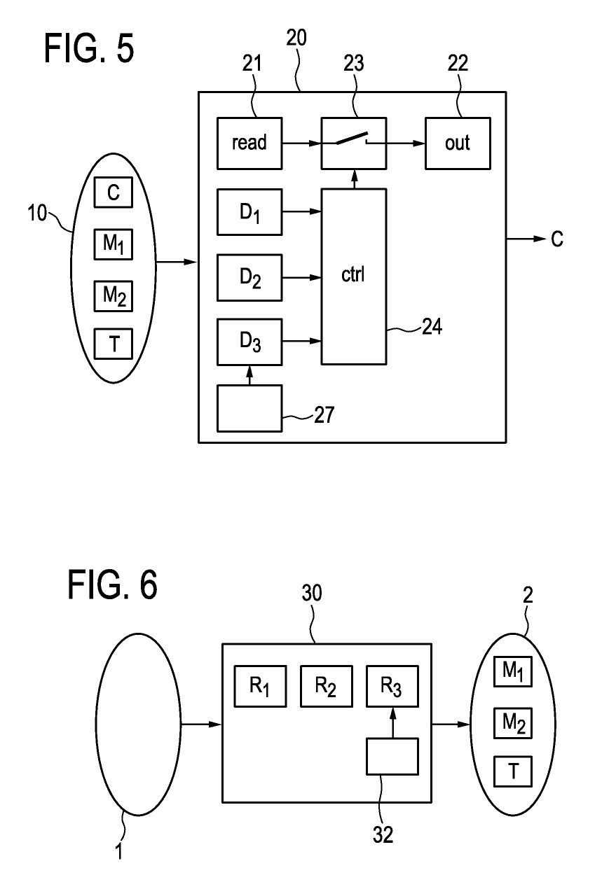

FIG. 5 schematically shows a third embodiment of a drive apparatus 20 according to the present invention. The drive apparatus 20 is again quite similar to the drive apparatus 20 as shown in FIG. 1. But now an additional storage unit 27 is provided for storing pieces of unique information used by the time-information detector D₃ for checking whether the time-indicative information T indicates the time that lies before a predetermined reference time.

In particular, this embodiment of the drive apparatus 20 takes account of the fact that the time-indicative information T now indirectly specifies a particular point in time. An embodiment of such an indirect indication is based on the use of random numbers generated by the time-information inserter R₃ (see the first manufacturing unit 30 in FIG. 3). During manufacture of the disc rather than a particular date of manufacturing the master or the final record carrier, a random number is generated and stored as time-indicative information T on the record carrier. A list of all used unique random numbers and corresponding data under use of the time-information inserter give the model to test whether a master of a record carrier (or the record carrier itself) has been made before a certain point in time.

For instance, if the time-information inserter generates unique random numbers for each master, then each drive apparatus 20 stores in the storage unit 27 all used random numbers, e.g. in a table, allowing the time-information detector D₃ to verify, based on the random number found on the record carrier 10, whether the master of the record carrier 10 (or the record carrier 10 itself) has been made before said certain point of time. In particular, if the random number found on the record carrier 10 is stored in the storage unit 27, it can be concluded that the record carrier 10 is an “old” record carrier not having a second ROM mark M₂, provided that the storage unit 27 stores only the random numbers used for record carriers not having second ROM marks, i.e. used until the use of second ROM marks has been introduced.

Rather than a random number, other unique information can, of course, also be used, such as a sequence number if during the manufacturing of record carriers consecutive sequence numbers are stored on the record carriers, i.e. if each new master gets a new sequence number that is appearing on all record carriers manufactured by the same master. Generally, all kinds of information can be used that indirectly allows to determine a time relationship and to carry out the step of checking C₁ explained above with reference to FIG. 2.

Alternatively, the random numbers or other unique information in 27 can also be stored more efficiently in a compressed form as explained in WO2001/086650.

A second embodiment of a first manufacturing unit 30 according to the present invention is shown in FIG. 6. The time-information inserter R₃ now is provided with unique information from a unique information generator 32. This unique information is inserted into the master 1 for later use by the drive apparatus as illustrated above with reference to FIG. 5, the unique information serving as indirect time-indicative information T.

According to a further embodiment of the present invention, the time-indicative information T is not only used for this single purpose, but serves one or more additional purposes. For instance, in one embodiment the time-indicative information T additionally serves to decrypt the content information C or content keys stored on the record carrier 10, i.e. the same information has been used during the manufacturing process to encrypt the content or content keys before it has been recorded on the record carrier 3 by the manufacturing unit 40 (see FIG. 3). Thus, if a hacker changes this information, it will no longer be able to correctly decrypt the content.

In a particular implementation, the time-indicative information is included in the first ROM mark, in particular in the payload of the first ROM mark. In this embodiment there is some natural protection for the time-indicative information (e.g. a date) in the ROM mark payload through the fact that its value is used to decrypt the content as proposed by AACS (as, for instance, described in section 2.4 in

http://www.aacsla.com/specifications/AACS_Spec_Prerecorded_{—}0.92.pdf). If the hacker changes the date, the player does not decrypt properly.

According to another, more secure embodiment, a certificate accompanying the content can be used to protect the time-indicative information T. For instance, every movie has to have a content certificate which is a statement assigned by AACS which approves this content for playback from BD-ROM, and HD-DVD ROM disc and other media. This certificate already contains some protected information indicative of time, e.g. “minimum CRL version”, which is a monotonically increasing number. Alternatively, an extra field could be introduced in the content certificate to indicate that the predetermined referenced introduction date for the second ROM Mark has been passed. Still further, a field in other certificates, e.g. a BD certificate (e.g. the BD-J root certificate, which is implicitly protected by the AACS content certificate) could be used.

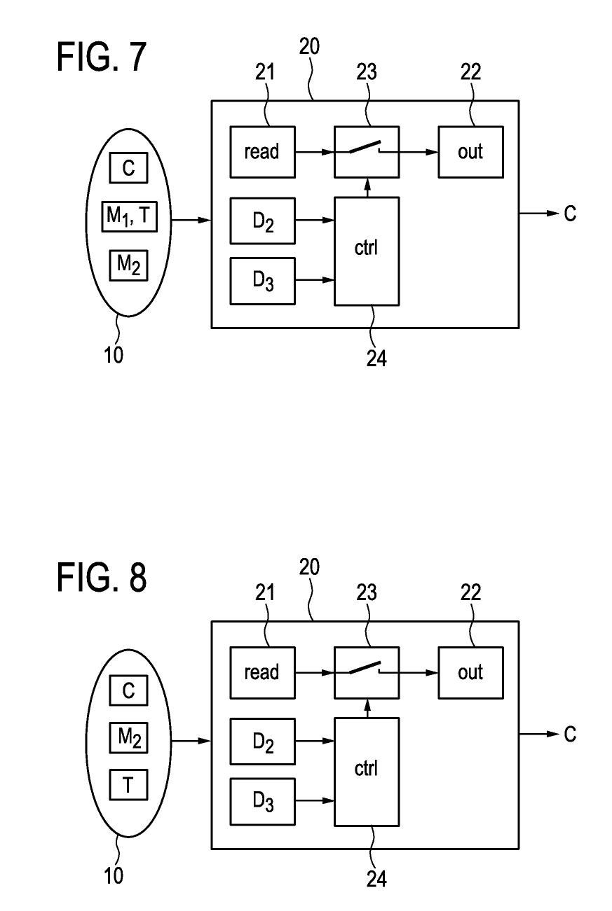

FIG. 7 shows a schematic block diagram of a fourth embodiment of the drive apparatus according to the present invention. According to this embodiment the time-indicative information T is now included in the first ROM mark M₁ of the record carrier 10. Further, compared to the first embodiment shown in FIG. 1, the drive 20 does not include a first ROM mark detector D₁, but only a second ROM mark detector D₂ and a time-information detector D₃. This means that the presence of the first ROM mark M₁ is not checked according to the present invention, i.e. the check C₀ of step S0 shown in the flow chart of FIG. 2 is now omitted. The remaining parts of the drive apparatus and of the flow chart as shown in FIGS. 1 and 2 are, however, identical and will thus not be described here in more detail.

This embodiment has the advantage that the drive apparatus needs to make less checks and thus can save one detector. On the other hand, however, it is well possible that the first ROM mark detector can be present as well in the drive.

A corresponding manufacturing apparatus looks quite similar as the manufacturing apparatus schematically illustrated in FIG. 3. The time-information inserter R₃ is now, however, provided for inserting the time-indicative information T into the first ROM mark M₁. In a modified embodiment of the manufacturing apparatus the first ROM mark inserter R₁ may be adapted to take over the function of the time-information inserter R₃ and thus may be enabled to directly insert the time-indicative information T to the first ROM mark M₁.

A schematic block diagram of a fifth embodiment of a drive apparatus according to the present invention is shown in FIG. 8. According to this embodiment no first ROM mark M₁ is provided at all on the record carrier 10, and the time-indicative information T is provided separately on the record carrier 10. Similarly as in the embodiment shown in FIG. 7 the drive 20 again does not include a first ROM mark detector D₁ but only checks for the presence of the second ROM mark M₂ by the second ROM mark detector D₂ if the time-indicative information T checked by the time-information detector D3 indicates that a second ROM mark M₂ should be present. If the record carrier 10, nevertheless, includes a first ROM mark M₁ in addition, it is simply ignored and not checked by the drive 20.

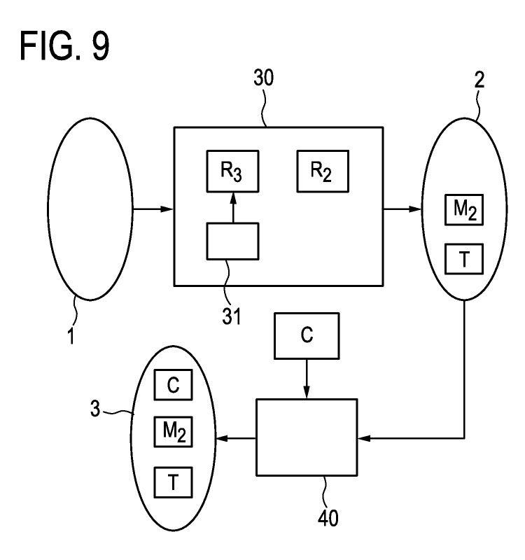

An embodiment of a corresponding manufacturing apparatus is schematically shown in FIG. 9. Different from the embodiment of the manufacturing apparatus shown in FIG. 3 the first manufacturing unit 30 now does not include a first ROM mark inserter R₁ since no first ROM mark M₁ shall be included in the master 2. Thus, on “new” record carriers which are manufactured after a certain reference time by the master 2 only the time-indicative information T and the second ROM mark M₂ are present, but no first ROM marks M₁.

Generally, it is not necessary that a hacker needs to know that a certain time-indicative information (or a first ROM mark including certain time-indicative information) would trigger a check for a second ROM mark. The disc might continue to play until the second ROM mark (preferably being located in the program area and not in the lead-in area) is found by the second ROM mark detector. If the second ROM mark is not found within a certain time, e.g. between 2 and 20 minutes, and the time-indicative information has indicated that a second ROM mark should be present, then the player stops to play back (generally, the access is stopped). The second ROM mark detector might be loaded with and be triggered by a specific sector number on the disc, so as to know where to start looking for the second ROM mark. If the second ROM mark is not found, the second ROM mark detector (generally an IC) generates a random number that determines how much time should pass before the player should stop. In this way, a hacker does not get a clear picture about why the player has stopped.

The present invention provides a simple and easily implementable method for controlling the access to a record carrier. It is based on the use of a time-indicative information T included in the record carrier, preferably in the known first ROM mark, and the use of a second ROM mark in addition.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measured cannot be used to advantage.

1. Drive apparatus (20) for accessing an optical record carrier (10) carrying a time-indicative information (T) and a second ROM mark (M₂), comprising:
an access unit (21, 25) for accessing said record carrier (10) for reading data from and/or writing data to said record carrier (10),
a time-information detector (D₃) for checking for the presence of time-indicative information (T) and for checking, if time-indicative information (T) is present, whether said time-indicative information (T) indicates a time that lies before a predetermined reference time,
a second ROM mark detector (D₂) for checking, if said time-indicative information (T) indicates a time that lies on or after said predetermined reference time, for the presence of said second ROM mark (M₂), and
a control unit (23, 24) for controlling said access unit (21, 25) such that the reading and/or writing of data is inhibited if said time-indicative information (T) indicates a time that lies on or after said predetermined reference time, but said second ROM mark (M₂) is not present on said record carrier.

2. Drive apparatus as claimed in claim 1 for accessing an optical record carrier (10) further carrying a first ROM mark (M₁), further comprising a first ROM mark detector (D₁) for checking for the presence of said first ROM mark (M₁).

3. Drive apparatus as claimed in claim 2 for accessing an optical record carrier (10) further carrying a first ROM mark (M₁), wherein said time-information detector (D₃) is adapted for checking for the presence of time-indicative information (T) in said first ROM mark (M₁).

4. Drive apparatus as claimed in claim 1, wherein said control unit (23, 24) is adapted for controlling said access unit (21, 25) such that the reading and/or writing of data is allowed if either said time-indicative information (T) is not present or if said time-indicative information (T) indicates a time that lies before said predetermined reference time, or if said second ROM mark (M₂) is present on said record carrier (10).

5. Drive apparatus as claimed in claim 1, wherein said first ROM mark detector (D₁) is adapted for checking for the presence of time-indicative information (T), which directly specifies a particular point in time, in particular the day on which the record carrier (10) or a master (3) used for manufacturing said record carrier (10) has been manufactured.

6. Drive apparatus as claimed in claim 1, wherein said time-information detector (D₃) is adapted for checking for the presence of time-indicative information (T), which indirectly specifies a particular point in time, in particular a unique information allowing to determine whether a record carrier (10) or a master (3) used for manufacturing the record carrier (10) has been manufactured before a predetermined reference point in time.

7. Drive apparatus as claimed in claim 6, further comprising a unique information storage (27) for storing all pieces of unique information that have been recorded on record carriers manufactured before, wherein said time-information detector (D₃) is adapted for checking a unique information detected on said record carrier against the pieces of unique information stored in said unique information storage (27).

8. Drive apparatus as claimed in claim 6, wherein said time-information detector (D₃) is adapted for detecting for the presence of a unique random number representing said unique information, wherein said drive apparatus (20) further comprises a random number storage (27) and wherein said time-information detector (D₃) is adapted for checking a random number detected on said record carrier against the random numbers stored in said random number storage (27).

9. Drive apparatus as claimed in claim 1, wherein said time-information detector (D3) is adapted for checking for the presence of time-indicative information (T) in a certificate stored on the record carrier (10), in particular a content certificate, content revocation list or a Blu-ray Disc certificate.

10. Drive method for accessing an optical record carrier (10) carrying a time-indicative information (T) and a second ROM mark (M₂), comprising the steps of:
accessing said record carrier for reading data from and/or writing data to said record carrier (10),
checking for the presence of time-indicative information (T),
checking, if time-indicative information (T) is present, whether the said time-indicative information (T) indicates a time that lies before a predetermined reference time,
checking, if said time-indicative information (T) indicates a time that lies on or after said predetermined reference time, for the presence of said second ROM mark (M₂), and
controlling said access unit (21, 25), such that the reading and/or writing of data is inhibited if said time-indicative information (T) indicates a time that lies on or after said predetermined reference time, but said second ROM mark (M₂) is not present on said record carrier (10).

11. Record carrier carrying a time-indicative information (T) for use by a drive apparatus (20) for checking whether said time-indicative information (T) indicates a time that lies before a predetermined reference time, and carrying a second ROM mark (M₂), said time-indicative information (T) and said second ROM mark (M₂) being provided for use by a drive apparatus (20) for deciding whether or not allowing access to said record carrier (10).

12. Record carrier as claimed in claim 11, wherein said time-indicative information (T) includes a date at which said record carrier (10) or a master (3) used for manufacturing said record carrier (10) has been manufactured.

13. Record carrier as claimed in claim 11, wherein said time-indicative information (T) includes a unique information allowing to decide whether said record carrier (10) or a master (3) used for manufacturing said record carrier (10) has been manufactured before a predetermined reference time.

14. Record carrier as claimed in claim 12, wherein said unique information includes a unique random number or a unique information.

15. Record carrier as claimed in claim 11, wherein said time-indicative information (T) is stored in a certificate, in particular a content certificate, content revocation list or a Blu-ray Disc certificate.

16. Record carrier as claimed in claim 11, wherein said time-indicative information (T) and/or said second ROM mark (M₂) rely on a variation of a physical parameter, in particular on a variation of a wobble of a pregroove of said record carrier (20).

17. Record carrier as claimed in claim 11, storing pieces of unique information used as time-indicative information (T) on other record carriers (20) manufactured before the manufacturing of the present record carrier (20) or the master (3) used for manufacturing the present record carrier (10).

18. Record carrier as claimed in claim 11, further storing content material (C) in encrypted form, which is encrypted such that time-indicative information (T) present on said record carrier (20) is to be used for decrypting said content material (C).

19. Manufacturing apparatus (30, 40) for manufacturing a record carrier (2, 3), comprising:
a time-information inserter (R₃) for inserting a time-indicative information (T) on said record carrier (2) for use by a drive apparatus (20) for checking for the presence of time-indicative information (T) on said record carrier and for checking, if time-indicative information (T) is present, whether said time-indicative information (T) indicates a time that lies before a predetermined reference time, and
a second ROM mark inserter (R₂) for inserting a second ROM mark (M₂) for use by said drive apparatus (20) for checking, if said time-indicative information (T) indicates a time that lies on or after said predetermined reference time, for the presence of said second ROM mark (M₂).

20. Manufacturing apparatus as claimed in claim 19, wherein said manufacturing apparatus (30, 40) is adapted for manufacturing a master (3) which is used for manufacturing a number of record carriers (10) having the same first and second ROM marks (M₁, M₂), wherein said time-indicative information (T) included in said first ROM marks (M₁) indicates the date at which said master (3) has been manufactured.

21. Manufacturing method for manufacturing a record carrier (2, 3), comprising the steps of:
inserting a time-indicative information (T) on said record carrier (2) for use by a drive apparatus (20) for checking for the presence of time-indicative information (T) on said record carrier and for checking, if time-indicative information (T) is present, whether said time-indicative information (T) indicates a time that lies before a predetermined reference time, and
inserting a second ROM mark (M₂) for use by said drive apparatus for checking, if said time-indicative information (T) indicates a time that lies on or after said predetermined reference time, for the presence of said second ROM mark (M₂).

22. Computer program comprising program code means for carrying out the steps of the method as claimed in claim 10, if said computer program is carried out on a computer.
